(19) United States
(12) Patent Application Publication
(10) Pub. No.: US 2016/0028265 A1
(43) Pub. Date: Jan. 28, 2016

(54) ULTRASONIC AND INFRARED OBJECT DETECTION FOR WIRELESS CHARGING OF ELECTRIC VEHICLES

(71) Applicant: Ford Global Technologies, LLC, Dearborn, MI (US)

(72) Inventors: Christopher W. BELL, Livonia, MI (US); John Paul GIBEAU, Canton, MI (US); James A. LATHROP, Saline, MI (US)

(21) Appl. No.: 14/338,628

(22) Filed: Jul. 23, 2014

(51) Int. Cl. H02J 7/02; G01V 11/00

(52) U.S. Cl. CPC H02J 7/025; G01V 11/00

(57) ABSTRACT

A wireless battery charging system for an electric vehicle can include a transmitter assembly configured to send a charging signal to a vehicle, an ultrasonic sensor configured to sense an unwanted object adjacent the transmitter assembly, and an infrared sensor configured to sense an unwanted object adjacent the transmitter assembly. The transmitter assembly includes a primary coil. The infrared sensor and the ultrasonic sensor can sense at least partially overlapping regions to sense an unwanted object in a coil region between the primary coil and a secondary coil of the vehicle.

### TECHNICAL FIELD

This disclosure relates to charging stations and the recharging of batteries in electric and hybrid electric vehicles.

### BACKGROUND

Charging methods for battery electric vehicles (BEVs) and plug-in hybrid electric vehicles (PHEVs) have increased in prevalence as advancements in vehicle propulsion and battery technology have occurred. Some charging methods include wireless charging, such as inductive charging. Inductive charging systems include a primary charging coil that is energized with an electric current. The primary charging coil induces a current in a secondary charging coil, which may be used to charge a battery.

### SUMMARY

A charging system can include a transmitter assembly, including a primary coil, configured to send a charging signal to a vehicle, a sensor arrangement including first and second ultrasonic sensor arrays partially defining a boundary of a coil region adjacent the primary coil, and an infrared sensor. The infrared sensor and arrays are positioned such that same portions of the coil region are sensed by each of the sensor and arrays.

A wireless battery charging system for charging a vehicle battery determines whether an unwanted object is near the charging coil. The system can include a transmitter assembly configured to send a charging signal to a vehicle, an ultrasonic sensor configured to sense an unwanted object adjacent the transmitter assembly, and an infrared sensor configured to sense an unwanted object adjacent the transmitter assembly. In an example, the transmitter assembly includes a primary coil, and the infrared sensor and the ultrasonic sensor overlap to sense an unwanted object in a coil region between the primary coil and a secondary coil of the vehicle. In an example, the ultrasonic sensor is configured to emit a high-frequency sound wave that reflects off an unwanted object and returns to the ultrasonic sensor. In an example, the charging signal is a radio frequency signal. In an example, the infrared sensor includes a dual-stage infrared sensor configured to detect infrared radiation of an unwanted object in the area that determines presence of the unwanted object and movement of the unwanted object. In an example, the infrared sensor includes presence-sensing circuitry to employ wavelength filtering to determine presence of the unwanted object. In an example, the infrared sensor includes movement-sensing circuitry to monitor landscape infrared data change, which indicates movement by the unwanted object. In an example, the transmitter assembly includes a controller configured to adjust the charging signal based on data from at least one of the ultrasonic sensor, the infrared sensor or both.

The ultrasonic sensor can include a first sensor array positioned along a first edge of the coil region and a second sensor array positioned along a second edge of the coil region such that sensors of the first sensor array sense in an area that partially overlaps a sensed area of sensors of the second sensor array. In an example, the first sensor array includes sensors that sense areas that overlap. In an example, the second sensor array includes sensors with sense areas that overlap. In an example, the infrared sensor is alongside sensors of the second sensor array.

The ultrasonic sensor can be configured to position the vehicle at the transmitter assembly such that a primary coil at the transmitter assembly is aligned with a secondary coil at the vehicle.

A method of wireless battery charging can include ultrasonically sensing an object located within a portion of a coil region that is adjacent a wireless power transmitter, thermally sensing the object located within the portion of the coil region; and in response to ultrasonically and thermally sensing the object located within the portion of the coil region, reducing power output by the wireless power transmitter.

A method of wireless battery charging can include ultrasonically sensing an unwanted object adjacent a power transmitter, thermally sensing the unwanted object adjacent the power transmitter, and controlling the power transmitter using the thermal sensed data and the ultrasonically sensed data. In an example, ultrasonically sensing and thermally sensing can, in detection regions, overlap to sense an unwanted object between a primary coil of a wireless charger and a secondary coil of the vehicle. In an example, controlling the power transmitter can include sending a charging signal to a coil on the vehicle. In an example, thermally sensing can include a dual-stage infrared sensor configured to detect infrared radiation of an unwanted object in the area. In an example, thermally sensing can include presence-sensing circuitry to employ wavelength filtering to determine presence of the unwanted object monitoring landscape infrared data change, which indicates movement by the unwanted object.

Ultrasonically sensing can include using a first sensor array positioned along a first edge of the coil region and a second sensor positioned array along a second edge of the coil region such that sensors of the first sensor array sense in an area that partially overlaps a sensed area of sensors of the second sensor array. The first sensor array includes sensors that sense areas that overlap, and the second sensor array includes sensors with sense areas that overlap.

Ultrasonically sensing can include sending a positioning signal to a vehicle at the transmitter assembly to assist in positioning the vehicle relative to a primary coil at a charging station and any detected unwanted objects.

A wireless charge system includes a transmitter assembly including a primary coil configured to generate a field to wirelessly transfer power to a secondary coil of a vehicle, and first and second ultrasonic sensor arrays arranged to partially define a boundary of a coil region adjacent the primary coil such that same portions of the coil region are sensed by each of the sensor arrays.

Various methods can be performed using the structures and systems described herein.

### BRIEF DESCRIPTION OF THE DRAWINGS

FIG. 1 is a schematic representation of a wireless charging system according to the present disclosure including a charging station and a plug-in vehicle;

FIG. 2 illustrates a schematic view for determining a position and horizontal offset of a vehicle according to the present disclosure;

FIG. 3 shows a perspective view of a transmitter assembly according to the present disclosure;

FIG. 4 is a cross sectional view taken generally along line 4-4 in FIG. 3;

FIG. 5 shows an operation of the lateral sensor array according to the present disclosure;

FIG. 6 shows an operation of the longitudinal sensor array according to the present disclosure;

FIG. 7 shows a method for vehicle charging according to the present disclosure; and

FIG. 8 shows a method for controlling a vehicle charging system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicles may be powered by battery electricity (BEVs) as well as by a combination of power sources including battery electricity. For example, hybrid electric vehicles (HEVs) are contemplated in which the powertrain is powered by both a battery and an internal combustion engine. In these configurations, the battery is rechargeable and a vehicle charger provides power to restore the battery after discharge.

Some vehicles and associated charging stations are equipped for hands-free wireless charging. To charge vehicles using such a system, the vehicle must be precisely located relative to the charger. A secondary charging coil in the vehicle must be positioned within a certain distance and orientation of a primary charging coil in order to effectively charge a vehicle battery.

One possible solution includes providing sensors on the vehicle that are equipped to detect a charging station location. However, such implementations must be sufficiently robust to function in the presence of displaced road debris including tire-propelled mud, ice, or dirt. Robust sensors capable of withstanding such road hazards may be expensive.

Moreover, the electromagnetic field created by the primary charging coil can create eddy currents in the region adjacent the primary charging coil. The present inventor has recognized the need to improve detection of unwanted objects in the area of the primary charging. In some examples, the region of concern is relatively small in relation to the primary charging coil, often on the order of twice the primary charging coil surface area. In a further example, it may be desirable to have a redundant object detection system since some methods have some inherent weaknesses. For example, the present infrared detection system can be used in combination with a magnetic resonance type “metal detector” for metallic object detection, a system that uses the main transmitter to detect unwanted objects, or combinations thereof.

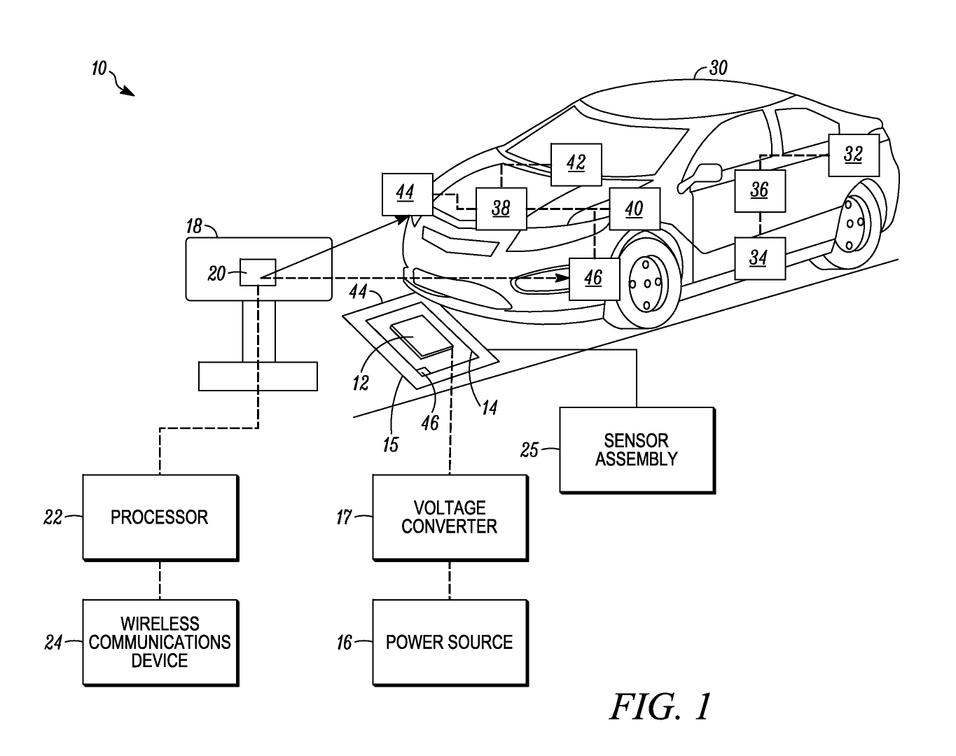

Referring now to FIG. 1, a charging system for a plug-in vehicle according to the present disclosure is illustrated in schematic form. The charging system includes a charging station 10. The charging station 10 is configured for inductive charging and includes a primary charging coil 12 housed within a primary induction charging assembly 14. The primary charging coil 12 is electrically connected to an electric power source 16 via a power converter 17. The power converter 17 converts current from the power source 16 to a different voltage and/or frequency and provides current to the primary charging coil 12. The primary charging coil 12 generates an electromagnetic field 15 about the primary induction charging assembly 14. When a corresponding secondary coil is placed in proximity to the powered primary induction charging assembly 14, it receives power by being within the generated electromagnetic field. The primary induction charging assembly 14 may, in some embodiments, be provided with an articulated arrangement to raise and lower the primary charging coil relative to a vehicle for charging.

The wireless charging station additionally includes a housing 18. The housing is positioned proximate the primary induction charging assembly 14. The housing 18 preferably includes a driver targeting aid to provide visual guidance to a driver. The driver targeting aid may include an arrow, a bull's-eye, crosshairs, or any other appropriate indicator of where to aim a vehicle for proper location relative to the primary induction charging assembly 14. The wireless charging station further includes a sensor 20. The sensor 20 is associated with the housing and is generally oriented toward the primary induction charging assembly 14. The sensor 20 is oriented to receive signals emitted in the vicinity of the primary induction charging assembly 14. In a preferred embodiment, the sensor 20 is an acoustic receiver. In some embodiments, other types of sensors may be used, or a combination of acoustic and other sensors may be used. Additional sensors may, of course, also be used.

The sensor 20 is in communication with a processor 22. The processor 22 may be configured to calculate a position of a vehicle or an unwanted object, including distance and horizontal offset, in response to signals from the sensor 20, as will be discussed below. The processor 22 is additionally in communication with a wireless communications device 24. The processor 22 is configured to transmit positional information of a vehicle to the vehicle via the wireless communications device 24. The processor 22 and wireless communications device 24 may be retained within the housing 18, primary induction charging assembly 14, or other appropriate location. Communications cables may run between the housing 18 and components retained within the primary induction charging assembly 14.

A sensor assembly 25 is provided that can include an ultrasonic sensor and/or a thermal sensor to sense an unwanted object adjacent the charging assembly 14. The sensors can overlap to provide greater accuracy in detection of the presence, movement and location of an unwanted object. Sensor assembly can emit and detect ultrasonic signals that reflect off an unwanted object. Based on the sensed signals at the sensor assembly 25, the operation of the charging assembly can be controlled, e.g., reducing power or turning off the charging signal, or resuming charging once a unwanted object is no longer in a region near the primary coil of the charging assembly. The nearness of an object depends on several factors, including the strength of the wireless charging signal from the charging assembly 14 to the vehicle, the materials adjacent the primary coil 12, and the strength of the electromagnetic field created by a charging signal from the charging assembly. The infrared sensor of the sensor assembly can include a dual-stage infrared sensor configured to detect infrared radiation of an unwanted object in the area that determines presence of the unwanted object and movement of the unwanted object. The sensing assembly 15 can include presence-sensing circuitry to employ wavelength filtering to determine presence of the unwanted object. That is a filter can be created based on the charging signal strength and the sensed region that is free from an unwanted object. This filter can be stored in the charging station. Sensor assembly 25 can include a controller or circuitry configured to adjust the charging signal based on data from at least one of the ultrasonic sensor, the infrared sensor or both. The sensor assembly 25 can also send positioning signals to the vehicle to be charged at the transmitter assembly to assist in aligning a secondary coil at the vehicle with a primary coil at the transmitter assembly.

Ultrasonically sensing can include sending a positioning signal to a vehicle at the transmitter assembly to assist in positioning the vehicle relative to a primary coil at a charging station and any detected unwanted objects

Vehicle 30 is a battery electric vehicle (BEV) or plug-in hybrid electric vehicle (PHEV). The vehicle 30 includes a battery 32 and a secondary induction coil 34. The secondary induction coil 34 generates current in response to an electromagnetic field generated by the primary induction coil 12. The vehicle 30 additionally includes an AC-to-DC converter 36. The converter 36 converts AC current generated by the secondary induction coil 34 to DC current to recharge the battery 32.

The vehicle 30 additionally includes at least one controller 38. Although it is shown as a single controller, the vehicle controller 38 can include multiple controllers that are used to control multiple vehicle systems. For example, the vehicle controller 38 can be a vehicle system controller/powertrain control module (VSC/PCM). In this regard, the vehicle charging control portion of the VSC/PCM can be software embedded within the VSC/PCM, or it can be implemented in a separate hardware device. The vehicle controller 38 generally includes any number of microprocessors, ASICs, ICs, memory (e.g., FLASH, ROM, RAM, EPROM and/or EEPROM) and software code to co-act with one another to perform a series of operations. The vehicle controller 68 additionally communicates with other controllers and components over a hardline vehicle connection using a common bus protocol (e.g. CAN). The controller(s) include circuitry to process various electrical signals to provide results that are used by the charging station or vehicle as described herein

The controller 38 is in electric communication with a vehicle wireless communications device 40. The vehicle wireless communications device 40 is in wireless communication with the charging station wireless communications device 24. In a preferred embodiment, the charging station wireless communications device 24 and vehicle wireless communications device 40 are both WiFi devices or cellular devices. Other wireless communications methods may of course be used, such as Bluetooth. The controller 38 is configured to receive positional information via the vehicle wireless communications device 40. The wireless communication between the vehicle wireless device 40 and charging station wireless communications device 24 may be used to transmit other information, as well. For example, the wireless communication may be used to complete an association procedure between the vehicle 30 and the charging station 10, in response to which vehicle charging may be initiated.

The controller 38 is additionally in communication with a driver display 42. The driver display may be a dashboard multifunction display or other displays as appropriate. The controller is configured to provide the positional information to a driver via the driver display 42. The driver display may include any appropriate representation of the vehicle positional information to illustrate the vehicle position and orientation, including distance and horizontal offset relative to the primary induction charging assembly 14. In response to this information, the driver may more accurately park the vehicle with the secondary induction coil 34 proximate the primary induction charging assembly 14.

The vehicle additionally includes a first sonic emitter 44 and a second sonic emitter 46. The sonic emitters 44 and 46 are in communication with the controller 38. The sonic emitters 44 and 46 are placed at specified locations near the front of the vehicle. In the embodiment illustrated, the first sonic emitter 44 is located on a passenger side of the vehicle and the second sonic emitter 46 is located on a driver side of the vehicle. The sonic emitters 44 and 46 are configured to emit bursts of sound at frequencies above those audible to humans. In a preferred embodiment, the first sonic emitter 44 and the second sonic emitter 46 are electrically connected on a same circuit. In this fashion, a command to generate an acoustic signal will trigger a simultaneous signal from both the first sonic emitter 44 and the second sonic emitter 46. The sonic emitters 44 and 46 can also emit a sonic signal to determine if an unwanted object is present in the region adjacent the primary induction coil 12. The sonic emitters 44, 46 can include receivers that sense the returned, e.g., reflected, sonic signals from within the region adjacent the primary induction coil 12. The sonic emitters 44, 46 can also be placed at the charging station, e.g., at the area 15 near the primary charging coil.

In some embodiments, the vehicle 30 is equipped with an auto park system. In such embodiments, a controller, which may be controller 38 or other appropriate controllers, issues commands to various vehicle systems to coordinate an automatic parking event. During an automatic parking event, vehicle steering, acceleration, and braking systems (not illustrated) are automatically controlled to park the car in an appropriate parking location and orientation. The controller will use the positional information from the charging station 10 to coordinate the various systems and park the vehicle with the secondary induction coil 34 proximate the primary induction charging assembly 14 for charging.

Variations of the above system are, of course, possible. For example, the sensor 20 may be operatively coupled to the primary induction charging assembly 14, rather than the housing 18 as illustrated in FIG. 1. In another variation, the sensor 20 is operatively coupled to the voltage converter 17. The above and other sensor locations may all be used in conjunction with methods according to the present disclosure. In some embodiments, the vehicle is equipped with an automatic parking system, and the positional information is used by an automatic parking system to facilitate hands-free parking.

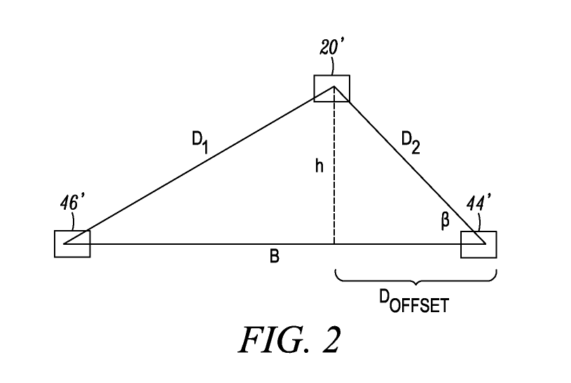

Referring now to FIG. 2, a method for determining a distance and horizontal offset of a vehicle according to the present disclosure is illustrated. A receiver 20′ is mounted near a desired parking spot. First and second emitters 44′ and 46′ are coupled to a front portion of a vehicle, spaced apart by a known distance B. The emitters 44′ and 46′ are configured to generate first and second sound bursts, respectively, at substantially the same time. The receiver 20′ receives the respective sound bursts generated by emitters 44′ and 46′ and timestamps the arrival of the sound bursts.

The system may calculate first and second time delays corresponding with the time elapsed between the generation of the sound bursts and the reception of the first and second sound bursts, respectively. Based on the speed of sound in air, the system may then calculate a first distance D₁ from the receiver 20′ to the first emitter 44′ and a second distance D₂ from the receiver 20′ to the second emitter 46′. With that information, along with the known distance B between the sound emitters 44′ and 46′, the charge system may generate a geometric triangle, the angles and sides of which represent positional information of the vehicle, including the distance of the vehicle from the receiver 20′ and how far offset the centerline of the vehicle is from the position of the receiver 20′. Performing geometric and trigonometric computations based on the received data, the vehicle location can be determined with a high degree of accuracy.

Heron's formula may be used to find the distance between the receiver 20′ and the vehicle.

$$S = \frac{B + {D}_{1} + {D}_{2}}{2}$$

$$A = \sqrt{S ( S - B ) ( S - {D}_{1} ) ( S - {D}_{2} )}$$

where A equals the area of the triangle defined by B, D₁, and D₂.

Substituting the above calculated area into the formula for the area of a triangle, one obtains

$$h = \frac{2 A}{B}$$

where h is the distance from the receiver 20′ to the vehicle.

Furthermore, the above-calculated figures may be used to determine an offset between the position of the receiver 20′ and the centerline of the vehicle. Using the Law of Cosines and the Pythagorean Theorem,

$$β = {cos}^{- 1} ( \frac{{B}^{2} + {D}_{2}^{2} - {D}_{1}^{2}}{2 {BD}_{2}} )$$

$${D}_{offset} = \frac{h}{tan β}$$

where D_{offset} is the horizontal offset between the receiver 20′ and the centerline of the vehicle.

Advantageously, triangulation based on first and second time delays, as discussed above, does not require line of sight between the first and second emitters and the receiver. Thus the receiver may be placed in a variety of locations regardless of the presence of visual obstructions between the receiver and emitters. Similar calculations can be performed to determine the position of an unwanted object

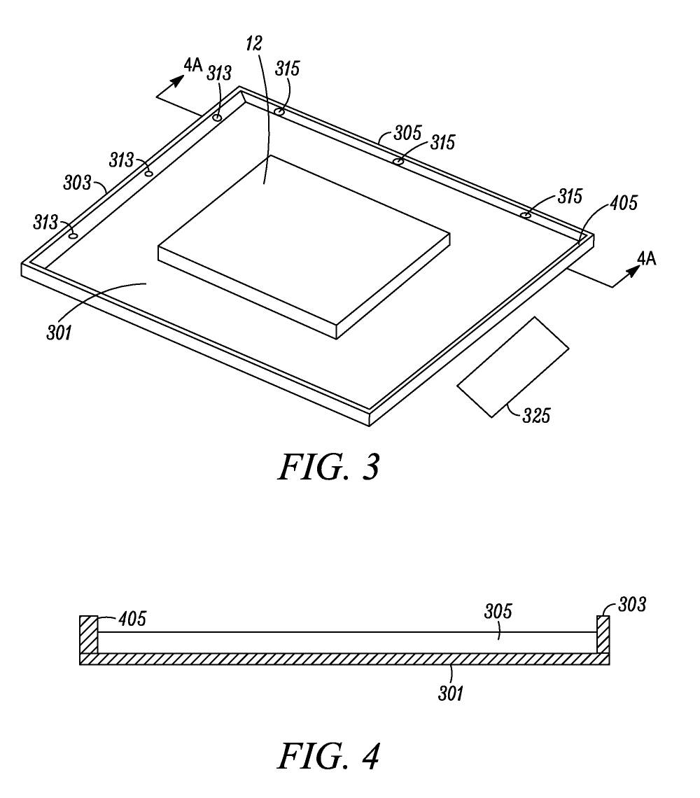

FIG. 3 shows an example of the primary induction charging assembly 14 including base 301, and first sensor array 303 and second sensor array 305, which partially define a boundary of a coil region. The base 301 can support the transmitter assembly 12, including the primary coil, which can be positioned centrally on the base 301. The first sensor array 303 is positioned along a lateral edge or in parallel with a lateral edge of the base 301. The first sensor array 303 is spaced from the transmitter. The first sensor array 303 can include a plurality of sensors 313, which can include an infrared sensor to detect an unwanted object using its heat signature and an ultrasonic sensor that detects presence of an object based on a transmitted acoustic wave and the received acoustic wave. The sensors 313, 315 can each include a sonic transmitter and a sonic receiver, which can be separate devices or integrated together in a transducer. The sensors 313, 315 can be positioned to provide total volumetric sensing with no blind spots at the transmitter assembly 12 and between the transmitter assembly and a vehicle positioned above the base 301. The infrared sensor(s) can be passive infrared sensor(s) which are specially aimed to cover all four corners of the area to be sensed, e.g., the entirety of the base 301 or an area greater than the base to detect and track movement of objects that may stray into an unwanted area including the area directly over the transmitter 12. The infrared sensor can detect thermal signatures of objects in an area up to 5 m×5 m (25 m²).

FIG. 4 shows a cross-sectional view of the primary induction charging assembly taken generally along line 4-4 in FIG. 3. With the sensor arrays, which include ultrasonic sensors, at edges of the primary induction charging assembly, e.g., at longitudinal and lateral edges of the base 301, the sensors in the sensor arrays can detect the distance to the edge of the pad ultrasonically. This can be used to verify operation of the sensors by checking the location of a known object, e.g., the opposite edge or a target 405, is at the proper location. That is a known object is detected and its location is confirmed. Data representing the opposite edge or the target 405 can be stored in memory and used by circuitry or processors to perform the self-check.

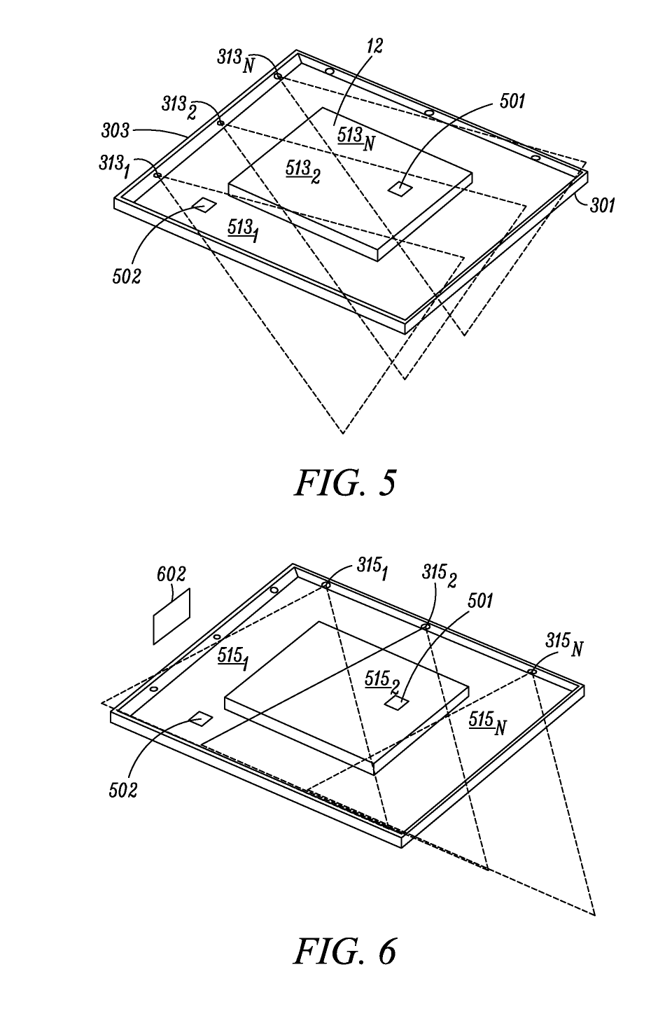

FIG. 5 shows a schematic view of the sensing area of first sensor array. Each sensor 313₁, 313₂, . . . 313_{N} of the first sensor array 303 emits a signal into its sensing coverage area 513₁, 513₂, . . . 513_{N}, respectively. The coverage areas 513₁, 513₂, . . . 513_{N} can overlap in some areas. Due to the nature of acoustic waves, these coverage areas are actually in three dimensions but are shown in two dimensions for ease of illustration. Example unwanted objects 501, 502 are illustrated. Object 501 is in the coverage areas 513₂, 513_{N} of both sensors 313₂, 313_{N}. As a result the signal from 313₂, 313_{N} are used to sense presence and location of the unwanted object 501. Object 502 is in the coverage areas 513₁ of sensor 313₁. As a result the signal from 313₁ is used to sense presence and location of the unwanted object 502.

FIG. 6 shows a schematic view of the sensing area of the second sensor array. Each sensor 315₁, 315₂, . . . 315_{N} of the second sensor array 305 emits a signal into its sensing coverage area 515₁, 515₂, . . . 515_{N}, respectively. The coverage areas 515₁, 515₂, . . . 515_{N} can overlap in some areas. The coverage areas 515₁, 515₂, . . . 515_{N} can also overlap the coverage areas 513₁, 513₂, . . . 513_{N}. Due to the nature of acoustic waves, these coverage areas are actually in three dimensions but are shown in two dimensions for ease of illustration. Like FIG. 5, unwanted objects 501, 502 are illustrated. Object 501 is in the coverage area 515₂ of sensors 315₂. As a result the signal from 315₂ is used to sense presence and location of the unwanted object 501. Object 502 is in the coverage areas 515₁ of sensor 315₁. As a result the signal from 315₁ is used to sense presence and location of the unwanted object 502. It will also be recognized that sensors from both the first sensor array 303 and the second sensor array 305 can be used to sense unwanted objects, e.g., sensors 313₁ and 315₁ both sense object 502. The sensors 313₁, 313₂, 313_{N}, 315₁, 315₂, and 315_{N} can each operate on a different frequency to not interfere with each other or interfere in a known way. The sensors can also be time multiplexed so as to not interfere, e.g., non-overlapping coverage area sensors can be operated at the same time but overlapping sensors do not operate at the same time. An infrared or thermal sensor 602 can be positioned so that it can sense both objects 501, 502 at the same time.

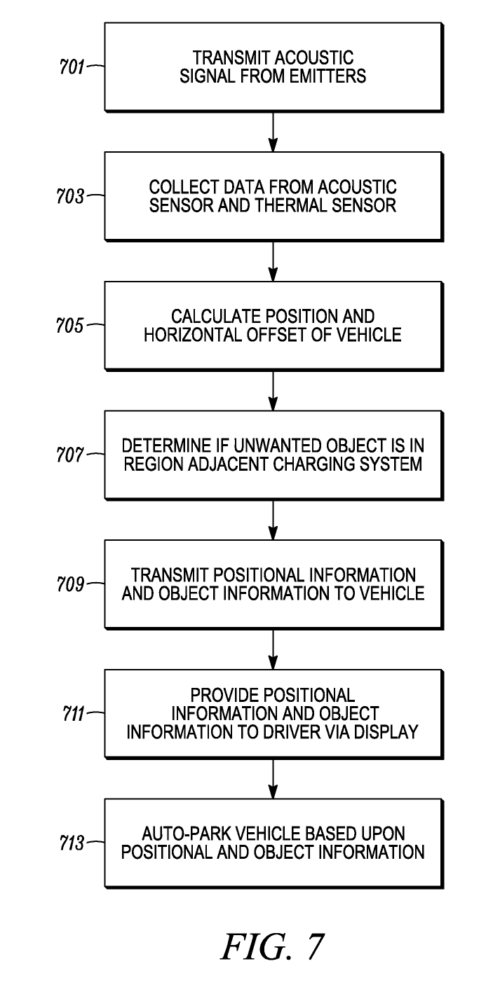

FIG. 7 shows a method for controlling a vehicle charging system according to the present disclosure. An acoustic signal is transmitted from emitters, step 701. The emitters can be on the vehicle, wireless charging station or primary coil structure. Data is collected from acoustic signals by acoustic sensor(s) and thermal data from thermal sensor(s), step 703. The returned acoustic signals can be indicative of objects in the field of view of the sensing structure, e.g., a large region to position and park the vehicle for charging and a region to detect unwanted objects adjacent the coil structures. The distance and horizontal offset to a detected vehicle is calculated, step 705. Unwanted objects in the region adjacent the charging system are detected, step 707. The detection and movement of unwanted objects can be performed by both acoustic detectors and infrared detectors. Positional information and unwanted object information are transmitted to the vehicle, step 709. Positional information and unwanted object information are provided to the driver via an in-vehicle display, step 711. In vehicles equipped with an auto-park system, the vehicle is automatically parked based upon the positional information and unwanted object information received from the charging station, step 713. The unwanted object position and presence information can also be used to control operation of the charging station, e.g., stop transmitting electromagnetic signal between the charging coil and the vehicle. The energy in the signal between the charging coil and the vehicle coil can be reduced.

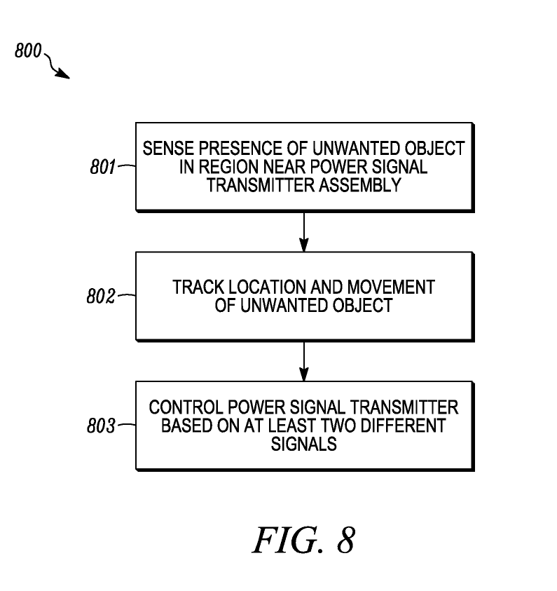

FIG. 8 shows a method 800 for controlling a vehicle charging system according to the present disclosure. At 801, sense the presence of an unwanted object in a region near or at the power signal transmitter assembly. The steps 801 and 802 can use a plurality of different signals, at least two of which are different types of signals, e.g., acoustic, sonic, infrared or thermal. The sensing can also include emitting signals, sensing signals, and converting the sensed signals into electric signals. The electric signals can be processed by circuitry to determine the presence of an unwanted object. At 802, the location and movement of the unwanted object(s) are tracked. Circuitry can be used to process sensed information to locate and track movement of unwanted objects. At 803, the operation of the power signal transmitter, e.g., the primary charging coil 12, uses the presence, location and movement data of the unwanted object.

In a variation of the above method, a vehicle with an auto-park system may be configured not to display positional information or unwanted object information to the driver, as the driver does not need to interact with the vehicle during the parking process. The auto-park system may take into account the location of the unwanted object to avoid the object when parking the vehicle at the charging station.

Additionally, variations may be utilized in other parking situations requiring precise vehicle location. A similar triangulation method may thus be used in vehicles that are not equipped with charging plates, but must be precisely located relative to a target for other purposes.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A charging system comprising:
a transmitter assembly, including a primary coil, configured to send a charging signal to a vehicle;
a sensor arrangement including first and second ultrasonic sensor arrays partially defining a boundary of a transmitter coil region adjacent the primary coil; and
an infrared sensor, the infrared sensor and ultrasonic sensor arrays being positioned such that same portions of the coil region are sensed by each of the sensor and arrays.

2. The charging system of claim 1, wherein the ultrasonic sensor arrays are configured to emit high-frequency overlapping sound waves that reflect off objects in the coil region and return to the ultrasonic sensor arrays.

3. The charging system of claim 1, wherein the charging signal is a radio frequency signal and wherein the first ultrasonic sensor array sends a first ultrasonic signal that overlaps a second ultrasonic signal from the second ultrasonic sensor array and the radio frequency signal.

4. The charging system of claim 1, wherein the infrared sensor includes a dual-stage infrared sensor configured to detect infrared radiation of objects in the transmitter coil region.

5. The charging system of claim 4, wherein the infrared sensor includes presence-sensing circuitry to employ wavelength filtering to determine presence of objects in the coil region.

6. The charging system of claim 5, wherein the infrared sensor includes movement-sensing circuitry to monitor landscape infrared data change indicative of movement of objects in the coil region.

7. The charging system of claim 1, wherein the transmitter assembly includes a controller configured to adjust the charging signal based on data from at least one of the sensor arrangement, ultrasonic sensor, or both.

8. The charging system of claim 1, wherein the infrared sensor is positioned alongside one of the ultrasonic sensor arrays.

9. A method of wireless battery charging comprising:
ultrasonically sensing an object located within a portion of a transmitter coil region that is adjacent a wireless power transmitter;
thermally sensing the object located within the portion of the coil region; and
in response to ultrasonically and thermally sensing the object located within the portion of the transmitter coil region, reducing power output by the wireless power transmitter.

10. The method of claim 9, wherein the ultrasonically sensing includes ultrasonically sensing, by each of overlapping first and second ultrasonic sensor arrays arranged to partially define a boundary of the transmitter coil region, the object located within the portion of the transmitter coil region.

11. The method of claim 9, wherein reducing power output by the wireless power transmitter includes reducing the power output to zero.

12. The method of claim 9 further comprising detecting movement of the object based on changes in a signal strength associated with the thermally sensing.

13. The method of claim 9 further comprising sending a signal to assist a vehicle in positioning a secondary coil attached thereto within the coil region.

14. A wireless charge system comprising:
a transmitter assembly including a primary coil configured to generate a field to wirelessly transfer power to a secondary coil of a vehicle; and
first and second ultrasonic sensor arrays arranged to partially define a boundary of a transmitter coil region adjacent the primary coil such that same portions of the coil region are sensed by both of the sensor arrays.

15. The system of claim 14 further comprising an infrared sensor arranged such that the same portions are sensed by each of the infrared sensor and the first and second ultrasonic sensor arrays.

16. The charging system of claim 15, wherein the infrared sensor includes a dual-stage infrared sensor configured to detect infrared radiation of objects in the coil region.

17. The charging system of claim 16, wherein the infrared sensor includes presence-sensing circuitry to employ wavelength filtering to determine presence of objects in the coil region.

18. The charging system of claim 17, wherein the infrared sensor includes movement-sensing circuitry to monitor landscape infrared data change indicative of movement of objects in the coil region.

19. The charging system of claim 15, wherein the infrared sensor is positioned alongside one of the arrays.

20. The system of claim 14, wherein the ultrasonic sensor arrays are configured to emit high-frequency sound waves that reflect off objects in the transmitter coil region and return to the arrays and wherein at least two sensors of the first and second ultrasonic sensor arrays overlap and sense a same part of the transmitter coil region.
